(19) United States
(12) Patent Application Publication
(10) Pub. No.: US 2015/0120840 A1
(43) Pub. Date: Apr. 30, 2015

(54) RESOURCE REFERENCING IN A COLLABORATION APPLICATION SYSTEM AND METHOD

(71) Applicant: International Business Machines Corporation, Armonk, NY (US)

(72) Inventors: DAVID L. ROSTOCIL, JR., Arlington, MA (US); Asima Silva, Holden, MA (US)

(73) Assignee: International Business Machines Corporation, Armonk, NY (US)

(21) Appl. No.: 14/066,042

(22) Filed: Oct. 29, 2013

(51) Int. Cl. H04L 29/06; H04L 12/58

(52) U.S. Cl. CPC H04L 65/403; H04L 51/04
USPC 709/206

(57) ABSTRACT

A method, computer program product, and computer system for identifying, by a first computing device, a resource associated with a collaboration session. A comment about at least a portion of the resource associated with the collaboration session is received. The comment is associated with at least the portion of the resource. A selection of at least one of the comment and at least the portion of the resource is received. The comment with at least the portion of the resource is provided for display to a second computing device in response to receiving the selection.

### BACKGROUND

During a collaboration session (e.g., web conference), attendees may have the ability to “chat” and make comments on the side, e.g., via an Instant Messaging application associated with the web conference. In some situations, such comments may be related to a specific resource, such as the slide currently being displayed or another attendee's comment. Attendees may not always be focused on the discussion, which may lead to confusion when they later return to read chat comments. A similar scenario may occur when an attendee is viewing a recorded web conference. For example, the content of the chat comments may be displayed in full at the start of the recording, which may make it difficult for the attendee to relate specific chat comments to specific resources.

### BRIEF SUMMARY OF DISCLOSURE

In one implementation, a method, performed by one or more computing devices, may include but is not limited to identifying, by a first computing device, a resource associated with a collaboration session. A comment about at least a portion of the resource associated with the collaboration session may be received. The comment may be associated with at least the portion of the resource. A selection of at least one of the comment and at least the portion of the resource may be received. The comment with at least the portion of the resource may be provided for display to a second computing device in response to receiving the selection.

One or more of the following features may be included. The comment may be received in an Instant Message chat session associated with the collaboration session. Associating the comment with at least the portion of the resource may include generating a link to a portion of the collaboration session displayed at a time when the comment is received. Associating the comment with at least the portion of the resource may include generating a link to at least the portion of the resource displayed at a time when the comment is received. Associating the comment with at least the portion of the resource may include receiving a selection of at least the portion of the resource to associate with the comment. Providing for display the comment with at least the portion of the resource to the second computing device may include providing for display each comment associated with at least the portion of the resource. Receiving the selection of at least one of the comment and at least the portion of the resource may include determining a viewable portion of at least one of the comment and at least the portion of the resource currently displayed at the second computing device.

In another implementation, a computing system includes a processor and a memory configured to perform operations that may include but are not limited to identifying, by a first computing device, a resource associated with a collaboration session. A comment about at least a portion of the resource associated with the collaboration session may be received. The comment may be associated with at least the portion of the resource. A selection of at least one of the comment and at least the portion of the resource may be received. The comment with at least the portion of the resource may be provided for display to a second computing device in response to receiving the selection.

One or more of the following features may be included. The comment may be received in an Instant Message chat session associated with the collaboration session. Associating the comment with at least the portion of the resource may include generating a link to a portion of the collaboration session displayed at a time when the comment is received. Associating the comment with at least the portion of the resource may include generating a link to at least the portion of the resource displayed at a time when the comment is received. Associating the comment with at least the portion of the resource may include receiving a selection of at least the portion of the resource to associate with the comment. Providing for display the comment with at least the portion of the resource to the second computing device may include providing for display each comment associated with at least the portion of the resource. Receiving the selection of at least one of the comment and at least the portion of the resource may include determining a viewable portion of at least one of the comment and at least the portion of the resource currently displayed at the second computing device.

In another implementation, a computer program product resides on a computer readable storage medium that has a plurality of instructions stored on it. When executed by a processor, the instructions cause the processor to perform operations that may include but are not limited to identifying, by a first computing device, a resource associated with a collaboration session. A comment about at least a portion of the resource associated with the collaboration session may be received. The comment may be associated with at least the portion of the resource. A selection of at least one of the comment and at least the portion of the resource may be received. The comment with at least the portion of the resource may be provided for display to a second computing device in response to receiving the selection.

One or more of the following features may be included. The comment may be received in an Instant Message chat session associated with the collaboration session. Associating the comment with at least the portion of the resource may include generating a link to a portion of the collaboration session displayed at a time when the comment is received. Associating the comment with at least the portion of the resource may include generating a link to at least the portion of the resource displayed at a time when the comment is received. Associating the comment with at least the portion of the resource may include receiving a selection of at least the portion of the resource to associate with the comment. Providing for display the comment with at least the portion of the resource to the second computing device may include providing for display each comment associated with at least the portion of the resource. Receiving the selection of at least one of the comment and at least the portion of the resource may include determining a viewable portion of at least one of the comment and at least the portion of the resource currently displayed at the second computing device.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an illustrative diagrammatic view of a reference process coupled to a distributed computing network according to one or more implementations of the present disclosure;

FIG. 2 is a diagrammatic view of a client electronic device of FIG. 1 according to one or more implementations of the present disclosure;

FIG. 3 is an illustrative flowchart of the reference process of FIG. 1 according to one or more implementations of the present disclosure;

FIG. 4 is an illustrative diagrammatic view of a screen image displayed by the reference process of FIG. 1 according to one or more implementations of the present disclosure;

FIG. 5 is an illustrative diagrammatic view of a screen image displayed by the reference process of FIG. 1 according to one or more implementations of the present disclosure;

FIG. 6 is an illustrative diagrammatic view of a screen image displayed by the reference process of FIG. 1 according to one or more implementations of the present disclosure;

FIG. 7 is an illustrative diagrammatic view of a screen image displayed by the reference process of FIG. 1 according to one or more implementations of the present disclosure; and

FIG. 8 is an illustrative diagrammatic view of a screen image displayed by the reference process of FIG. 1 according to one or more implementations of the present disclosure.

Like reference symbols in the various drawings indicate like elements.

### DETAILED DESCRIPTION

### System Overview

As will be appreciated by one skilled in the art, the present disclosure may be embodied as a method, system, or computer program product. Accordingly, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of this document, a computer-usable or computer-readable, storage medium may be any tangible medium that can contain or store a program for use by or in connection with the instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. The computer readable program code may be transmitted using any appropriate medium, including but not limited to the internet, wireline, optical fiber cable, RF, etc. A computer readable signal medium may be any computer readable medium that is not a computer readable storage medium and that can communicate, propagate, or transport a program for use by or in connection with an instruction execution system, apparatus, or device.

Computer program code for carrying out operations of the present disclosure may be written in an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript or PERL. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider).

The flowchart and block diagrams in the figures illustrate the architecture, functionality, and operation of possible implementations of apparatus (systems), methods and computer program products according to various implementations of the present disclosure. It will be understood that each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some alternative implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

The computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

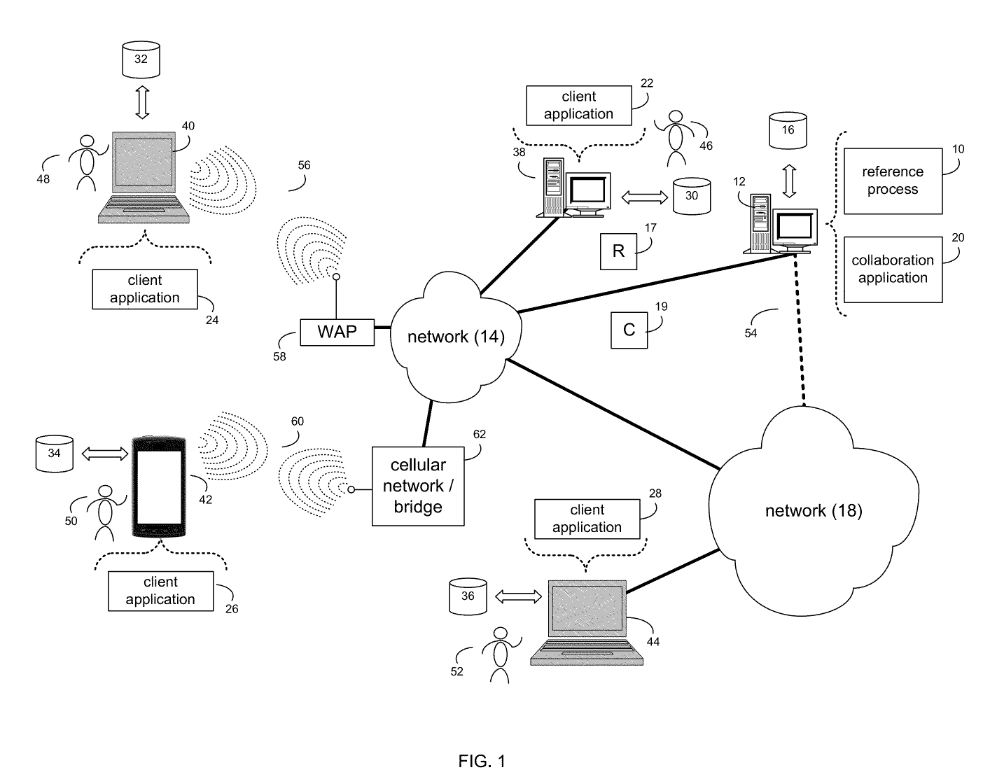

Referring to FIG. 1, there is shown reference process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a personal computer(s), a laptop computer(s), mobile computing device(s), a server computer, a series of server computers, a mainframe computer(s), or a computing cloud(s). Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

As will be discussed below in greater detail, reference process 10 may identify, by a first computing device, a resource (e.g., resource 17) associated with a collaboration session. A comment (e.g., comment 19) about at least a portion of the resource associated with the collaboration session may be received. The comment may be associated with at least the portion of the resource. A selection of at least one of the comment and at least the portion of the resource may be received. The comment with at least the portion of the resource may be provided for display to a second computing device in response to receiving the selection.

The instruction sets and subroutines of reference process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

Computer 12 may execute a collaboration application (e.g., collaboration application 20), examples of which may include, but are not limited to, e.g., a web conferencing application, a video conferencing application, a voice-over-IP application, a video-over-IP application, an Instant Messaging application, or other application that allows for virtual meeting and/or remote collaboration. Reference process 10 and/or collaboration application 20 may be accessed via client applications 22, 24, 26, 28. Reference process 10 may be a stand alone application, or may be an applet/application/script that may interact with and/or be executed within collaboration application 20 and/or one or more of client applications 22, 24, 26, 28. Collaboration application 20 may be a stand alone application, or may be an applet/application/script that may interact with and/or be executed within reference process 10 and/or one or more of client applications 22, 24, 26, 28. One or more of client applications 22, 24, 26, 28 may be a stand alone application, or may be an applet/application/script that may interact with and/or be executed within reference process 10 and/or collaboration application 20. Examples of client applications 22, 24, 26, 28 may include, but are not limited to, e.g., a web conferencing application, a video conferencing application, a voice-over-IP application, a video-over-IP application, an Instant Messaging application, or other application that allows for virtual meeting and/or remote collaboration, a standard and/or mobile web browser, an email client application, a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36 coupled to client electronic devices 38, 40, 42, 44, may be executed by one or more processors (not shown) and one or more memory architectures (not shown) incorporated into client electronic devices 38, 40, 42, 44.

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet (not shown), a server (not shown), a television (not shown), a smart television (not shown), a media (e.g., video, photo, etc.) capturing device (not shown), and a dedicated network device (not shown). Client electronic devices 38, 40, 42, 44 may each execute an operating system, examples of which may include but are not limited to, Android™, Apple® iOS®, Mac® OS X®; Red Hat® Linux®, or a custom operating system.

One or more of client applications 22, 24, 26, 28 may be configured to effectuate some or all of the functionality of reference process 10 (and vice versa). Accordingly, reference process 10 may be a purely server-side application, a purely client-side application, or a hybrid server-side/client-side application that is cooperatively executed by one or more of client applications 22, 24, 26, 28 and/or reference process 10.

One or more of client applications 22, 24, 26, 28 may be configured to effectuate some or all of the functionality of collaboration application 20 (and vice versa). Accordingly, collaboration application 20 may be a purely server-side application, a purely client-side application, or a hybrid server-side/client-side application that is cooperatively executed by one or more of client applications 22, 24, 26, 28 and/or collaboration application 20. As one or more of client applications 22, 24, 26, 28, reference process 10, and collaboration application 20, taken singly or in any combination, may effectuate some or all of the same functionality, any description of effectuating such functionality via one or more of client applications 22, 24, 26, 28, reference process 10, collaboration application 20, or combination thereof, and any described interaction(s) between one or more of client applications 22, 24, 26, 28, reference process 10, collaboration application 20, or combination thereof to effectuate such functionality, should be taken as an example only and not to limit the scope of the disclosure.

Users 46, 48, 50, 52 may access computer 12 and reference process 10 (e.g., using one or more of client electronic devices 38, 40, 42, 44) directly through network 14 or through secondary network 18. Further, computer 12 may be connected to network 14 through secondary network 18, as illustrated with phantom link line 54. Reference process 10 may include one or more user interfaces, such as browsers and textual or graphical user interfaces, through which users 46, 48, 50, 52 may access reference process 10.

The various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, Wi-Fi®, and/or Bluetooth™ device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown directly coupled to network 14.

Some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

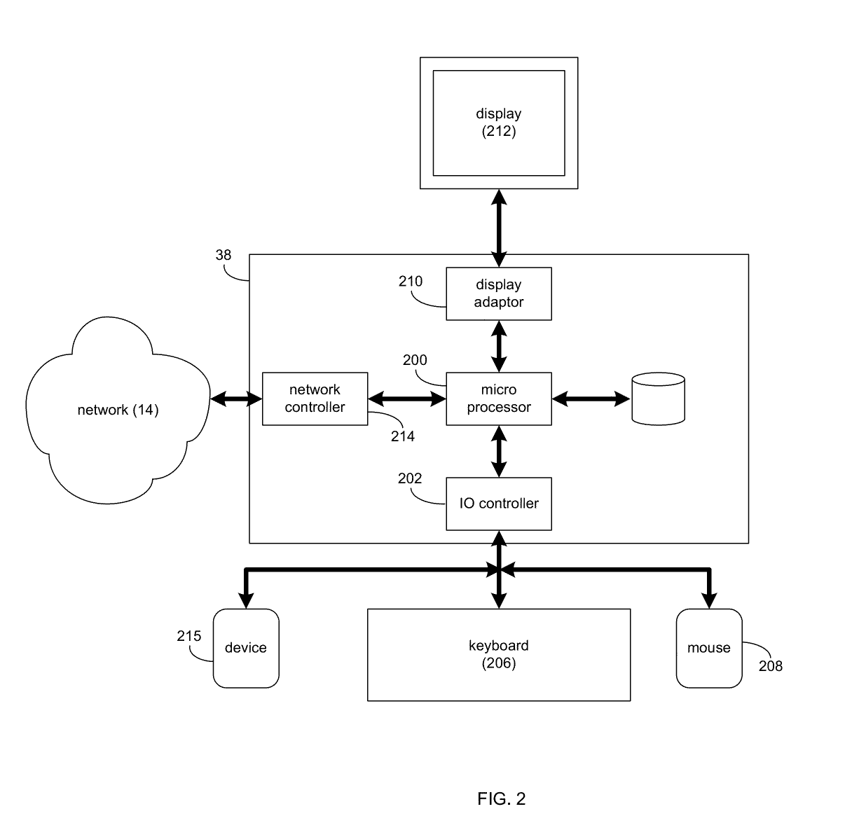

Referring also to FIG. 2, there is shown a diagrammatic view of client electronic device 38. While client electronic device 38 is shown in this figure, this is for illustrative purposes only and is not intended to be a limitation of this disclosure, as other configurations are possible. For example, any computing device capable of executing, in whole or in part, reference process 10 may be substituted for client electronic device 38 within FIG. 2, examples of which may include but are not limited to computer 12 and/or client electronic devices 40, 42, 44.

Client electronic device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device. An I/O controller (e.g., I/O controller 202) may be configured to couple microprocessor 200 with various devices, such as keyboard 206, pointing/selecting device (e.g., mouse 208), custom device (e.g., device 215), USB ports (not shown), and printer ports (not shown). A display adaptor (e.g., display adaptor 210) may be configured to couple display 212 (e.g., CRT or LCD monitor(s)) with microprocessor 200, while network controller/adaptor 214 (e.g., an Ethernet adaptor) may be configured to couple microprocessor 200 to the above-noted network 14 (e.g., the Internet or a local area network).

The Reference Process:

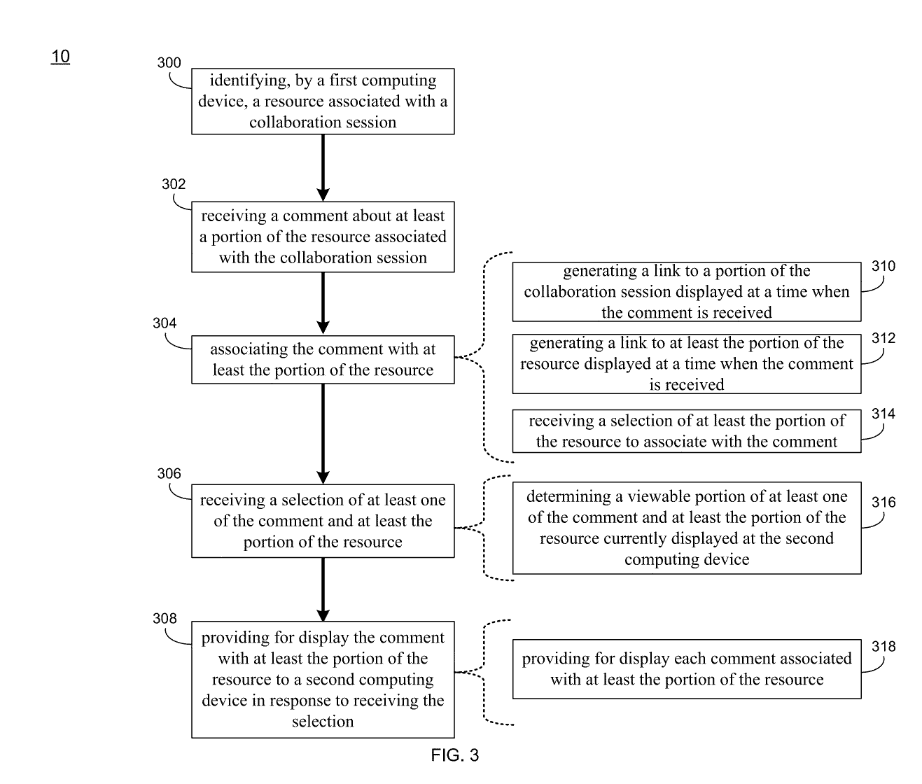

As discussed above and referring also to FIGS. 3-8, reference process 10 may identify 300, by a first computing device (e.g., computer 12), a resource (e.g., resource 17) associated with a collaboration session. A comment (e.g., comment 19) about at least a portion of resource 17 associated with the collaboration session may be received 302 by reference process 10. Comment 19 may be associated 304 with at least the portion of resource 17 by reference process 10. A selection of at least one of comment 19 and at least the portion of resource 17 may be received 306 by reference process 10. Reference process 10 may provide 308 for display comment 19 with at least the portion of resource 17 to a second computing device (e.g., client electronic device 38) in response to receiving 306 the selection.

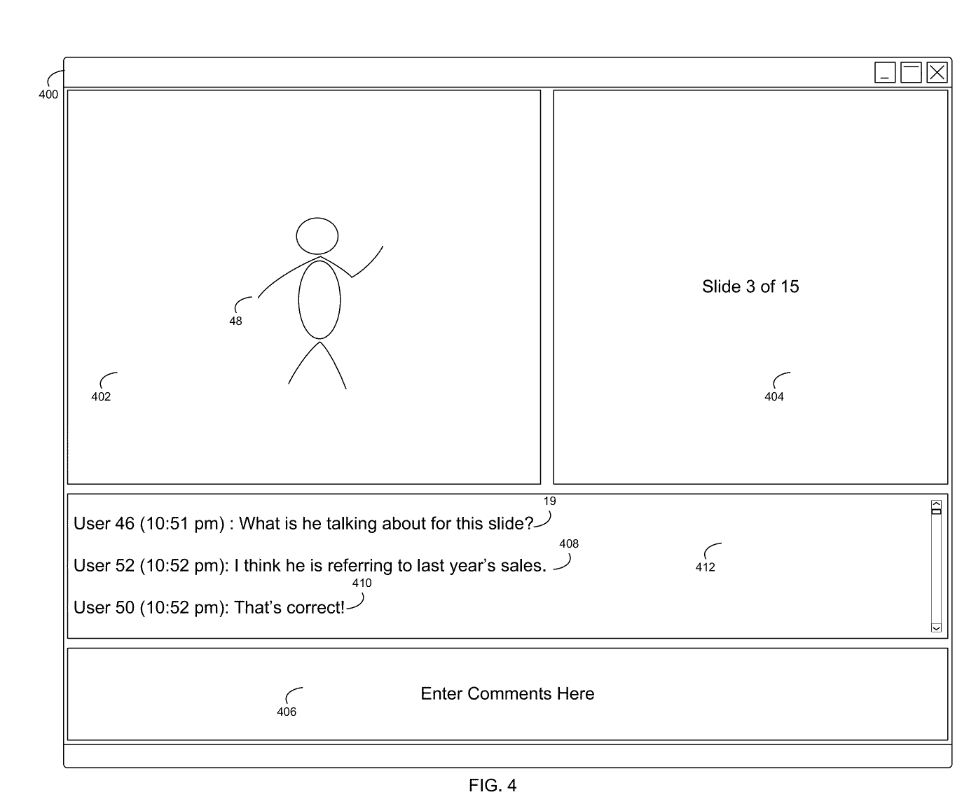

In some implementations, reference process 10 may identify 300, by a first computing device (e.g., computer 12), a resource (e.g., resource 17) associated with a collaboration session (e.g., a web conference). For instance, and referring at least to FIG. 4, assume for example purposes only that a web conference is underway involving users 46, 48, 50, and 52. An example user interface (UI 400) is shown to include, e.g., a main window object (e.g., main window 402) that may display for the remaining attendees of the web conference the video feed for the main speaker (e.g., user 48). UI 400 may also include resource window object (e.g., resource window 404) that may display for the remaining attendees of the web conference the particular resource (e.g., resource 17) that user 48 is talking about during the web conference. For instance, in the example, resource 17 may be a slide show, which user 48 may be discussing during the web conference. In some implementations, resource 17 may include the entire slide show and/or a portion of the slide show (e.g., one or more slides of the entire slide show). Other examples of resource 17 may include but are not limited to, e.g., a local/remote document and/or file, one or more pages of the local/remote document and/or file, a web page, as well as one or more comments received 302 during the web conference (as will be discussed in greater detail below). As such, the use of a slide show (or particular slide(s)) as resource 17 should be taken as an example only and not to limit the scope of the present disclosure.

A comment (e.g., comment 19) about at least a portion of resource 17 associated with the collaboration session may be received 302 by reference process 10. For example, and still referring at least to FIG. 4, UI 400 may also include a comment object (e.g., comment object 406) that may enable each user respectively to enter comments that may be seen in display comment object (e.g., display comment object 412) display by one or more of the attendees. For instance, users 46, 52, and 50 respectively may enter comments 19, 408, and 410 about slide #3 of 15 shown in resource window 404 that may be received 302 by reference process 10. In some implementations, comment 19 may be received 302 in an Instant Message chat session associated with collaboration session 20.

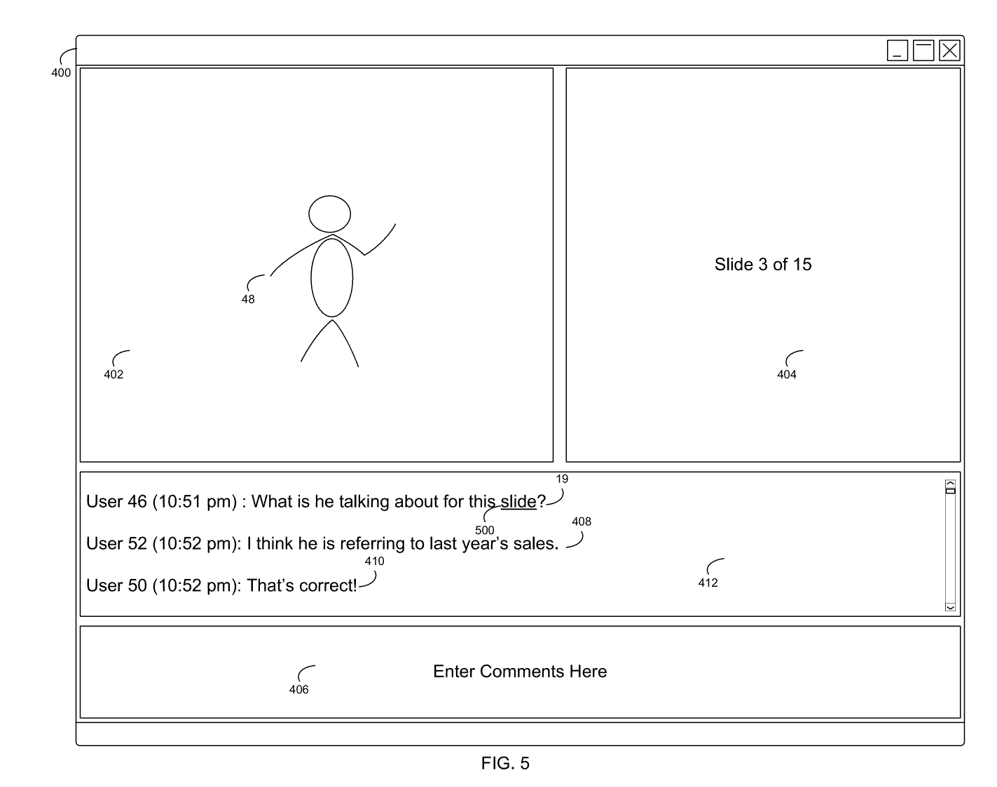

In some implementations, comment 19 may be associated 304 with at least the portion of resource 17 by reference process 10. For example, associating 304 comment 19 (e.g., tree node) with at least the portion of resource 17 may include reference process 10 generating 310 a link to a portion of the collaboration session displayed at a time when comment 19 is received 302. For instance, and referring at least to FIG. 5, assume for example purposes only that users 46, 52, and 50 respectively may enter comments 19, 408, and 410 about slide #3 of 15 that may be received 302 by reference process 10 when slide #3 of 15 is being shown in resource window 404. In the example, because slide #3 of 15 is currently being displayed when, e.g., comments 19, 408, and 410 are received 302, reference process 10 may generate 310 a link (e.g., link 500) to slide #3 of 15 as shown within the web conference. As will be discussed in greater detail below, a user, e.g., user 46, may use a pointing device (e.g., mouse 208) to “click” on link 500, which may cause slide #3 of 15 to be provided 308 for display to user 46. In some implementations, one or more screen shots of UI 400 that include the web conference may be taken by reference process 10 periodically, e.g., each time a new comment is received 302. In the example, link 500 may be generated 310 and associated 304 with the particular screenshot taken when the new comment is received 302. As a result, “clicking” on link 500 may cause reference process 10 to provide 308 the screenshot for display to user 46. Link 500 may include but is not limited to, e.g., a database link, URL, as well as a pointer to the above-noted screenshot.

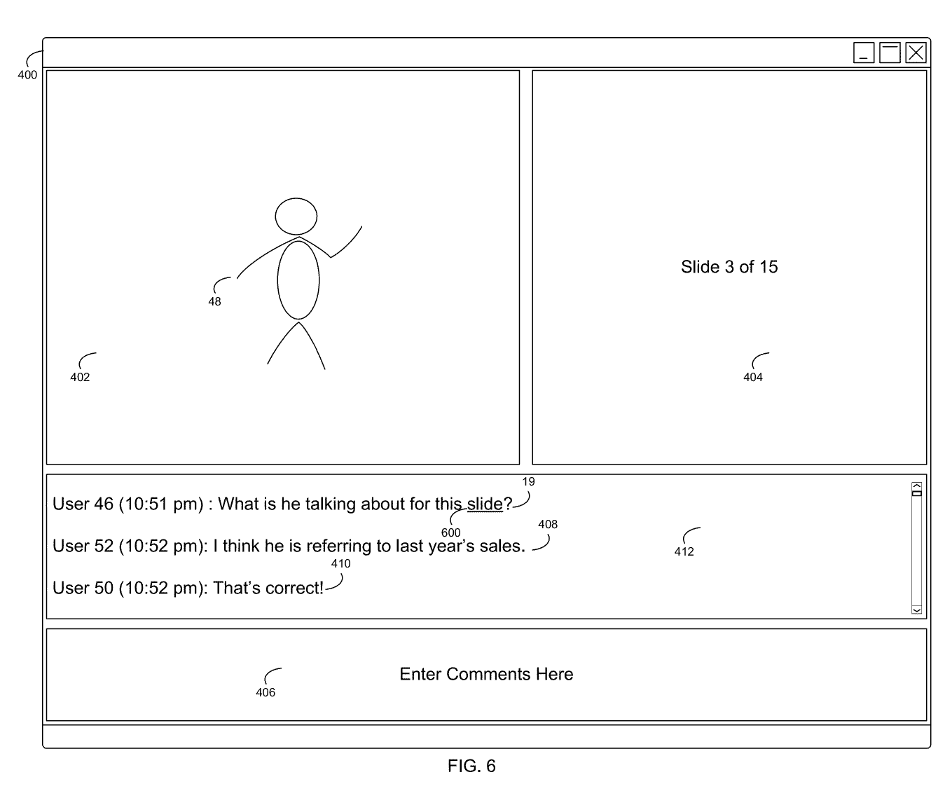

Associating 304 comment 19 with at least the portion of resource 17 may include reference process 10 generating 312 a link to at least the portion of resource 17 displayed at a time when comment 19 is received 302. For instance, and referring at least to FIG. 6, assume for example purposes only that users 46, 52, and 50 respectively may enter comments 19, 408, and 410 about slide #3 of 15 that may be received 302 by reference process 10 when slide #3 of 15 is being shown in resource window 404. In the example, because slide #3 of 15 is currently being displayed when, e.g., comments 19, 408, and 410 are received 302, reference process 10 may generate 312 a link (e.g., link 600) to slide #3 of 15. As will be discussed in greater detail below, a user, e.g., user 46, may use a pointing device (e.g., mouse 208) to “click” on link 600, which may cause slide #3 of 15 to be provided 308 for display to user 46. It will be appreciated that the above-noted link may be generated at any time during and/or after the web conference.

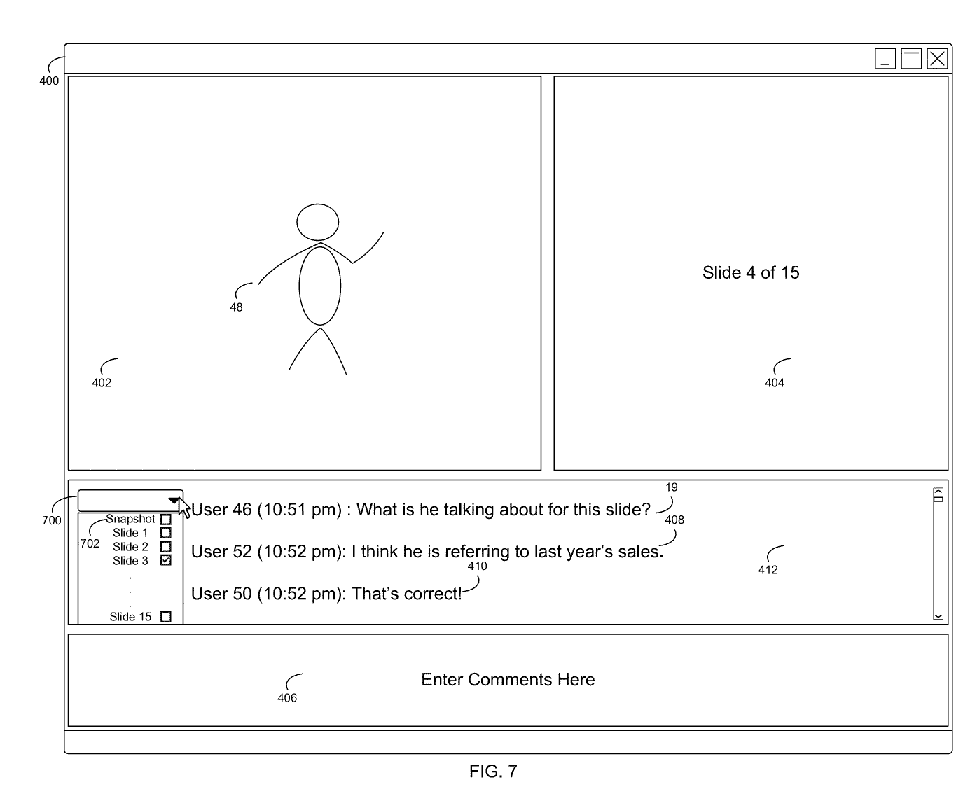

In some implementations, associating 304 comment 19 with at least the portion of resource 17 may include reference process 10 receiving 314 a selection of at least the portion of resource 17 to associate 304 with comment 19. For example, and referring at least to FIG. 7, assume for example purposes only that users 46, 52, and 50 respectively may enter comments 19, 408, and 410 about slide #3 of 15 that may be received 302 by reference process 10 when slide #4 of 15 is being shown in resource window 404. In the example, even though slide #4 of 15 is currently being displayed when, e.g., comments 19, 408, and 410 are received 302, reference process 10 may still associate 304 comment 19 with slide #3 of 15. For instance, at any time, UI 400 may enable reference process 10 (e.g., through user 46 and/or mouse 208) to receive 314 a selection of, e.g., a drop down menu, such as drop down menu 700, which may further enable reference process 10 (through user 46 and/or mouse 208) to receive 314 a selection of “Slide 3” (and/or multiple slides). As a result, reference process 10 may associate 304 comment 19 with slide #3 of 15 (and/or one or more other slides for which a selection is received 314). Additionally/alternatively, in some implementations, drop down menu 700 may include an option to associate 304 comment 19 with a current view (e.g., snapshot) of the web conference, by similarly receiving 314 a selection of “Snapshot” option 702 within drop down menu 700. In some implementations, receiving 314 the above-noted selection may similarly cause reference process 10 to generate 310/312 a link (not shown) to comment 19, slide #3 of 15, and/or the snapshot generated upon receiving 314 the above-noted selection. It will be appreciated that the above-noted links may be generated at any time during and/or after the web conference.

In some implementations, a selection of at least one of comment 19 and at least the portion of resource 17 may be received 306 by reference process 10. For instance, as noted above, and as will be discussed in greater detail below, a user, e.g., user 46, may use a pointing device (e.g., mouse 208) to “click” on link 500 to thereby receive 306 a selection of comment 19, which may cause slide #3 of 15 and/or the appropriate screenshot to be provided 308 for display to user 46. Similarly, as noted above, and as will be discussed in greater detail below, a user, e.g., user 46, may use a pointing device (e.g., mouse 208) to “click” on link 600, which may cause slide #3 of 15 to be provided 308 for display to user 46. It will be appreciated that any of the above-noted links may be generated 310/312 and displayed on the resource itself (e.g., slide #3 of 15).

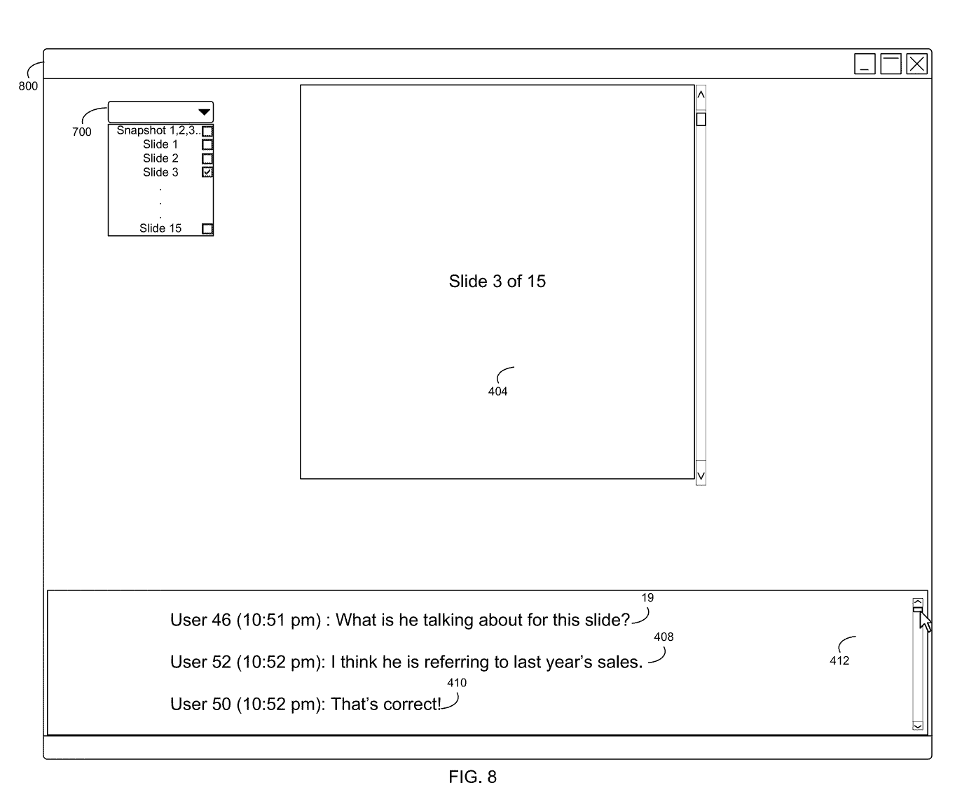

In some implementations, receiving 306 the selection of at least one of comment 19 and at least the portion of resource 17 may include reference process 10 determining 316 a viewable portion of at least one of comment 19 and at least the portion of resource 17 currently displayed at client electronic device 38. For instance, and referring at least to FIG. 8, assume for example purposes only that after the web conference has concluded, user 46 is reviewing all the comments received 302 during the web conference in display comment object 412, e.g., via a reviewing user interface (e.g., UI 800). In the example, user 46 may, but need not, open and replay the recorded web conference for such a review. Reference process 10, via user 46 and/or mouse 208, may receive 306 a command to scroll or otherwise browse the comments in display comment object 412. In the example, further assume that while scrolling, reference process 10 determines 316 that at least comment 19 is displayed in display comment object 412.

In some implementations, reference process 10 may provide 308 for display comment 19 with at least the portion of resource 17 to a second computing device (e.g., client electronic device 38) in response to receiving 306 the selection. For example, in response to receiving 306 the scroll command and/or determining 316 that at least comment 19 is displayed in display comment object 412 (e.g., while scrolling), reference process 10 may provide 308 for display comment 19 with the associated 304 resource (e.g., slide #3 of 15), which may be displayed, e.g., proximate to each other.

Similarly, assume for example purposes only that after the web conference has concluded, user 46 is reviewing all the slides displayed in resource window 404 during the web conference, e.g., via the above-noted UI 800. Reference process 10, via user 46 and/or mouse 208, may receive 306 a command to scroll or otherwise browse the slides in resource window 404. In the example, further assume that while scrolling, reference process 10 determines 316 that at least slide #3 of 15 is displayed in resource window 404. Similarly as noted above, in response to receiving 306 the scroll command and/or determining 316 that at least slide #3 of 15 is displayed in resource window 404 (e.g., while scrolling), reference process 10 may provide 308 for display comment 19 with the associated 304 resource (e.g., slide #3 of 15), which may be displayed, e.g., proximate to each other. Similarly, in some implementations, UI 800 may enable user 46 to use a pointing device (e.g., mouse 208) to select drop down menu 700 options that may be received 306 by reference process 10 to “jump to” the appropriately selected snapshot, slide, comment, or combination thereof, where (assuming the snapshot, slide, and/or comment associated with comment 19 and/or slide #3 of 15 were selected) reference process 10 may then provide 308 for display comment 19 with the associated 304 slide #3 of 15, which may be displayed, e.g., proximate to each other. Similarly, receiving 306 a selection of any of the above-noted links may cause reference process 10 to provide 308 for display comment 19 with the associated 304 resource (e.g., slide #3 of 15), which may be displayed, e.g., proximate to each other.

In some implementations, providing 308 for display comment 19 with at least the portion of resource 17 to client electronic device 38 may include reference process 10 providing 318 for display each comment associated with at least the portion of resource 17. For instance, and continuing with the above example, further assume that while scrolling, reference process 10 determines 316 that at least slide 3 is displayed in resource window 404. Similarly as noted above, in response to receiving 306 the scroll command and/or determining 316 that at least slide 3 is displayed in resource window 404 (e.g., while scrolling), reference process 10 may provide 308 for display comment 19 and all received 302 comments associated 304 with slide 3 (e.g., comments 19, 408, and 410), which may be displayed, e.g., proximate to each other. Similarly, receiving 306 a selection of any of the above-noted links may cause reference process 10 to provide 308 for display comment 19 and all received 302 comments associated 304 with slide 3 (e.g., comments 19, 408, and 410), which may be displayed, e.g., proximate to each other.

While one or more implementations are described as occurring after the web conference has concluded, it will be appreciated that one or more of the implementations may equally occur at other times, e.g., during the web conference. As such, the description of one or more implementations occurring after the web conference has concluded should be taken as an example only and not to limit the scope of the present disclosure.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, and any combinations thereof will be apparent to those of ordinary skill in the art without departing from the scope and spirit of the disclosure. The implementation(s) were chosen and described in order to best explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, and combinations thereof) are possible without departing from the scope of the disclosure defined in the appended claims.

What is claimed is:

1. A computer-implemented method comprising:
identifying, by a first computing device, a resource associated with a collaboration session;
receiving a comment about at least a portion of the resource associated with the collaboration session;
associating the comment with at least the portion of the resource;
receiving a selection of at least one of the comment and at least the portion of the resource; and
providing for display the comment with at least the portion of the resource to a second computing device in response to receiving the selection.

2. The computer-implemented method of claim 1 wherein the comment is received in an Instant Message chat session associated with the collaboration session.

3. The computer-implemented method of claim 1 wherein associating the comment with at least the portion of the resource includes generating a link to a portion of the collaboration session displayed at a time when the comment is received.

4. The computer-implemented method of claim 1 wherein associating the comment with at least the portion of the resource includes generating a link to at least the portion of the resource displayed at a time when the comment is received.

5. The computer-implemented method of claim 1 wherein associating the comment with at least the portion of the resource includes receiving a selection of at least the portion of the resource to associate with the comment.

6. The computer-implemented method of claim 1 wherein providing for display the comment with at least the portion of the resource to the second computing device includes providing for display each comment associated with at least the portion of the resource.

7. The computer-implemented method of claim 1 wherein receiving the selection of at least one of the comment and at least the portion of the resource includes determining a viewable portion of at least one of the comment and at least the portion of the resource currently displayed at the second computing device.

8. A computer program product residing on a computer readable storage medium having a plurality of instructions stored thereon which, when executed by a processor, cause the processor to perform operations comprising:
identifying, by a first computing device, a resource associated with a collaboration session;
receiving a comment about at least a portion of the resource associated with the collaboration session;
associating the comment with at least the portion of the resource;
receiving a selection of at least one of the comment and at least the portion of the resource; and
providing for display the comment with at least the portion of the resource to a second computing device in response to receiving the selection.

9. The computer program product of claim 8 wherein the comment is received in an Instant Message chat session associated with the collaboration session.

10. The computer program product of claim 8 wherein associating the comment with at least the portion of the resource includes generating a link to a portion of the collaboration session displayed at a time when the comment is received.

11. The computer program product of claim 8 wherein associating the comment with at least the portion of the resource includes generating a link to at least the portion of the resource displayed at a time when the comment is received.

12. The computer program product of claim 8 wherein associating the comment with at least the portion of the resource includes receiving a selection of at least the portion of the resource to associate with the comment.

13. The computer program product of claim 8 wherein providing for display the comment with at least the portion of the resource to the second computing device includes providing for display each comment associated with at least the portion of the resource.

14. The computer program product of claim 8 wherein receiving the selection of at least one of the comment and at least the portion of the resource includes determining a viewable portion of at least one of the comment and at least the portion of the resource currently displayed at the second computing device.

15. A computing system including a processor and a memory configured to perform operations comprising:
identifying, by a first computing device, a resource associated with a collaboration session;
receiving a comment about at least a portion of the resource associated with the collaboration session;
associating the comment with at least the portion of the resource;
receiving a selection of at least one of the comment and at least the portion of the resource; and
providing for display the comment with at least the portion of the resource to a second computing device in response to receiving the selection.

16. The computing system of claim 15 wherein the comment is received in an Instant Message chat session associated with the collaboration session.

17. The computing system of claim 15 wherein associating the comment with at least the portion of the resource includes generating a link to a portion of the collaboration session displayed at a time when the comment is received.

18. The computing system of claim 15 wherein associating the comment with at least the portion of the resource includes generating a link to at least the portion of the resource displayed at a time when the comment is received.

19. The computing system of claim 15 wherein associating the comment with at least the portion of the resource includes receiving a selection of at least the portion of the resource to associate with the comment.

20. The computing system of claim 15 wherein providing for display the comment with at least the portion of the resource to the second computing device includes providing for display each comment associated with at least the portion of the resource.
